(19) United States
(12) Patent Application Publication
(10) Pub. No.: US 2006/0059331 A1
(43) Pub. Date: Mar. 16, 2006

(54) Console-less boot

(76) Inventors: Daniel V. Zilavy, Fort Collins, CO (US); Leo J. Embry, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 10/941,704

(22) Filed: Sep. 15, 2004

(51) Int. Cl. G06F 9/24

(52) U.S. Cl. 713/2

(57) ABSTRACT

Systems, methodologies, media, and other embodiments associated with a system boot are described. One exemplary system embodiment includes a system for a computing device that includes at least a console. The example system includes a boot logic configured to detect whether communication with the console is functional or non-functional and to allow the computing device to boot with a non-functional console.

### BACKGROUND

Some computer systems include a console that can display information and may also allow the input of information by way of a keyboard or other input device. The console can be connected to the computer system, for example, through a communication port having a universal asynchronous receiver/transmitter (UART). The UART is a computer component that can manage serial ports and can handle asynchronous serial communication to connected serial devices.

In many computer systems if the console fails, for example due to a non-functioning UART, the system will shut down and attempt to reboot. However, during the rebooting process, the system may not successfully reboot or initialize due to the lack of a functioning console. As such, the operating system cannot be loaded and the computer system does not become operable.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system for booting a computing device without a functional console.

FIG. 2 illustrates another example system for booting a computing system without a functional transceiver/console.

FIG. 3 illustrates an example console driver for handling a non-functional console.

FIG. 4 illustrates an example methodology that may be associated with a system boot process.

FIG. 5 illustrates an example methodology that may be associated with an operating system during a boot process.

FIG. 6 illustrates an example computing environment in which example systems and methods illustrated herein can operate.

### DETAILED DESCRIPTION

Example systems, methods, media and other embodiments are described herein that can be associated with a system boot of a computing system. In one example system for a computing device that includes at least a console, the example system includes a boot logic configured to detect whether communication with the console is functional or non-functional and allows the computing system to boot with a non-functional console.

The example system may be useful for a computing system that can sufficiently perform its duties without a functioning console. For example, if the console fails or communication between the console and the computing system is lost, such as by a failed universal asynchronous receiver/transceiver (UART), the computing device may halt operations and attempt a reboot. Rather than having the reboot fail, the example system can help the computing system successfully reboot in the absence of a functioning UART, and thus without a functioning console. The overall availability of the computing device can thus be increased.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks, firmware, and so on. Volatile media may include, for example, semiconductor memories, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, a flag, a parameter, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, detecting, continuing, determining, identifying, mapping, or the like, refer to actions and processes of a computer system, logic, processor, or similar electronic device that manipulates and transforms data represented as physical (electronic) quantities.

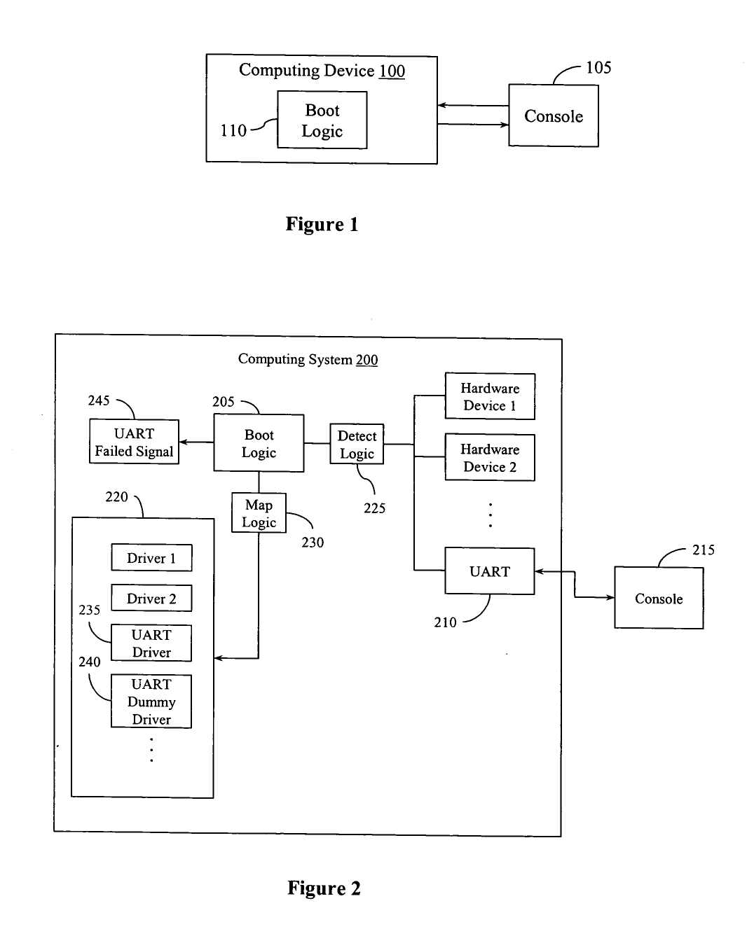

Illustrated in FIG. 1 is one example system for a computing device 100 that includes at least a console 105 such as a display terminal. The console 105 can be operably connected to the computing device 100 through a communication port and a transceiver that is configured to provide communication therebetween. The transceiver can be, for example, a universal asynchronous receiver/transmitter (hereinafter UART), a virtual UART, or other communication logic capable of processing communications between the computing device 100 and the console 105. In the examples herein, the term “UART” will be used interchangeably with the term “transceiver” and it is intended that the term UART refers to transceivers in general. UART also may include a USART (Universal Synchronous-Asynchronous Receiver/Transmitter). Other types of input/output controllers and logic are also within the scope of the examples.

One example UART can include a microchip programmed to control the computer's interface to attached serial devices like the console 105. The UART can provide the computing device 100 with an RS-232C Data Terminal Equipment (DTE) interface so that it can “talk” to and exchange data with serial devices. One example of a virtual UART can include a microprocessor programmed to log communication data, forward the data to a physical port, mirror the data, and send the data over a network connection, or any combination of these tasks.

The system includes a boot logic 110 that can be configured to detect whether the communication with the console 105 is functional or non-functional and to allow the computing device 100 to boot with a non-functional console 105. In one example, the boot logic 110 can be embodied as system firmware within the computing device 100, as a computer component, as software, and the like. In one example scenario, suppose that communication with the console 105 is lost due to a failed UART. The computing device 100 may stop functioning (e.g. crash) and may attempt to reboot by initiating a boot process. The boot logic 110 can operate during the boot process to cause the boot process to believe that the UART is functional so that the UART can be successfully initialized without an error. Assuming that no other errors occur, the boot can successfully complete even with a non-functional UART. An operating system can then be successfully loaded to allow the computing device 100 to be available for operation but without a functioning console 105.

Illustrated in FIG. 2 is another example computing system 200 that includes another example boot logic 205 configured to control a boot process of the computing system 200. The boot logic 205 may be, for example, system firmware. In the following example, the computing system 200 will be described as having a plurality of hardware devices 1, 2, etc., and a UART 210 configured to provide communication with a console 215. The computing system 200 may also contain one or more drivers 220 where a driver is software that controls a hardware device and acts as a translator between the hardware device and programs that use the hardware device. One or more of the drivers 220 may be maintained in various locations within the computing system 200 and/or may be maintained on remote devices.

During a system boot of the computing system 200, a system initialization may be performed that, among other functions, determines which hardware devices are available to the computing system 200. The system boot may be triggered by, for example, powering on the computing system 200, an automatic reboot due to a system error (e.g. a failed UART or other device), a manual reboot, and the like. During the boot process, the boot logic 205 is configured to detect whether the UART 210 is functional or non-functional. If the UART 210 is non-functional, the boot logic 205 is configured to load a UART driver operable to allow the boot process to continue as though the UART 210 was functional.

The boot logic 205 can include a detect logic 225 that is configured to detect whether the UART 210 is functional or not. This may be performed, for example, by sensing its presence and attempting to initialize the UART 210. If the UART 210 does not respond, it will be determined as non-functional, which will cause the console 215 to be non-functional. A map logic 230 can be configured to map, or otherwise load, a corresponding driver from the drivers 220 associated with a detected hardware device. For example, if the UART 210 is functional, a UART driver 235 can be loaded that corresponds to the UART 210. In response to a detected non-functional UART 210, a dummy UART driver 240 can be mapped in that allows the computing system 200 to boot without communication with the console 215. In another example, the UART driver 235 and the dummy UART driver 240 can be configured as a single driver that includes logic to operate with a functioning UART and a non-functioning UART. In this manner, the boot process can continue even when a failed UART 210 is detected so that initialization can complete and the operating system can be loaded.

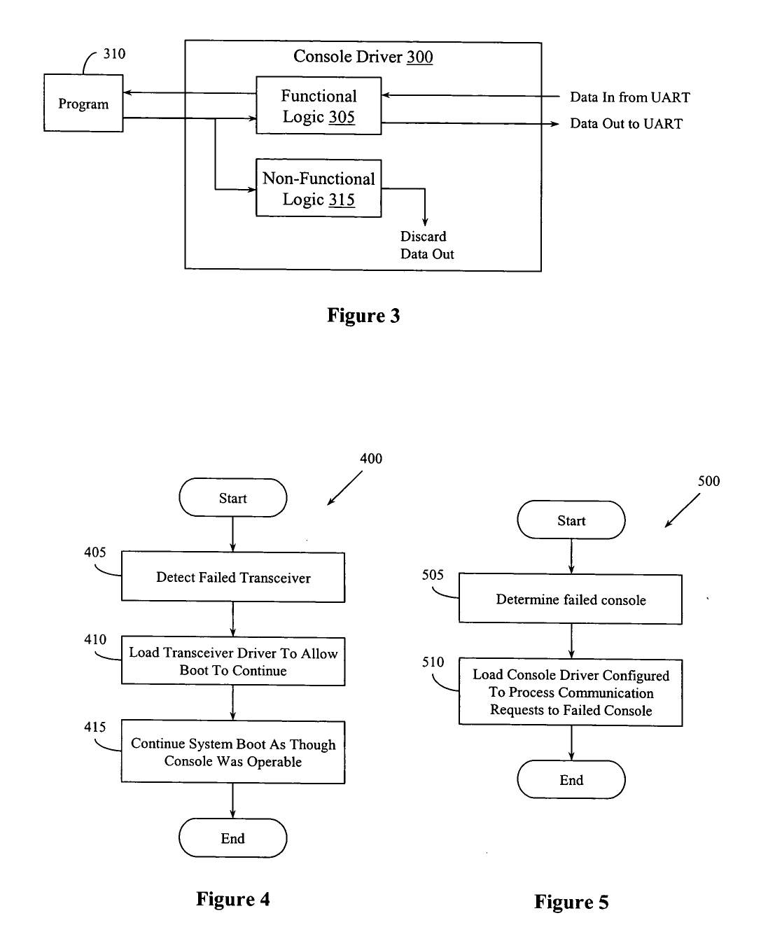

In another example, the boot logic 205 can set a flag such as a UART failed signal 245 that indicates a failed UART 210 is present. The failed signal 245 can then be accessible by the operating system during its initialization. The UART failed signal 245 can be configured to cause the operating system to load a console/UART driver configured to allow the operating system to process communication requests directed to the console 215 without transmitting data to the console 215. In one example, the operating system can be programmatically modified to read the UART failed signal 245 and also to recognize that a functioning UART is not available. In general, the UART failed signal 245 is a signal that is placed in a location accessible by the operating system. In one example on a PA-RISC system, the failed signal 245 can be implemented by placing a null path in page 0. The operating system can read the path written in page 0 and determine that no UART is available. The operating system can then respond accordingly by loading a console driver configured to process communications with the failed UART 210. One example of a console driver that may be used is described with reference to FIG. 3.

Illustrated in FIG. 3 is one example of a console driver 300 that can be used by an operating system in response to having a failed UART, or otherwise, a failed console. The console driver 300 is configured to handle both situations of a functional UART and a non-functional UART. For example, functional logic 305 can be configured to handle normal communication requests that may be received from a program 310 and are directed to a console. Appropriate commands can then be transmitted to the UART (e.g. data out to UART) that correspond to the requests.

However, in the case of a non-functional UART, the console driver 300 can be caused to execute a non-functional logic 315 that can process communications with a failed UART. For example, data that is requested to be written (from the program 310) to the console can be received by the non-functional logic 315 and be discarded rather than transmitting the data to the UART. The requesting program 310 can be unaware that the data was discarded or that any type of error occurred. Additionally, since the UART is not operable in this situation, no data will be received from the console, thus, no data will be received by the console driver 300 from the UART (e.g. no “data in from UART”). As such, there is no data transmitted from the non-functional logic 315 back to the program 310. Examples of discarding the data may include writing the data in a memory or file, logging the data, deleting the data, and the like. The data from the program 310 is not transmitted to the console even though the program 310 has provided instructions to write the data to the console.

The non-functional logic 315 can be regarded as a dummy UART driver or dummy console driver that serves a purpose of appearing as a functioning console to the other components of the computing system. It will also be appreciated that two separate console drivers can be used where one handles a functioning console corresponding to the functional logic 305 and the other is a dummy driver corresponding to the non-functional logic 315. The operating system can be configured to load the appropriate driver based on the functionality of the UART.

Although the previous examples have described two different dummy drivers, one driver being loaded before the operating system is loaded and the other driver being loaded by the operating system, other configurations can be used. For example, the two drivers can be the same driver that are loaded at two different times. In another example, a computing system may be configured to use one driver for a hardware device where the driver is loaded during a boot or initialization process. Thus, only one driver is used. Therefore, the example systems and methods described herein can be modified and adapted to different types of systems.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that various actions could occur concurrently, substantially in parallel, and/or at substantially different points in time.

Illustrated in FIG. 4 is one exemplary methodology 400 that can be associated with booting a system that includes a failed transceiver (e.g. UART). The illustrated elements denote “processing blocks” that may be implemented in logic. In one example, the processing blocks may represent executable instructions that cause a computer, processor, and/or logic device to respond, to perform an action(s), to change states, and/or to make decisions, and the like. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), a programmable logic device, or other logic device. The diagram of FIG. 4, as well as the other illustrated diagrams, are not intended to limit the implementation of the described examples. Rather, the diagrams illustrate functional information one skilled in the art could use to design/fabricate circuits, generate software, or use a combination of hardware and software to perform the illustrated processing. The foregoing applies to all methodologies and examples described herein.

With reference to FIG. 4, the example methodology 400 will be described as part of a system boot process. The system boot may be triggered by, for example, powering on a computing system, an automatic reboot due to a system error, a manual reboot, and the like. In this example, it will be presumed that a transceiver, which that controls communication with a console, has failed. The transceiver can be a UART.

After the system boot is initiated, at some point a determination is made as to whether the transceiver is functional and the process can detect a failed transceiver (Block 405). If the transceiver has failed, a transceiver driver is loaded to allow the system boot to continue (Block 410). The transceiver driver can be a dummy driver made to appear as though a functional transceiver is present. The system boot can then continue as though the transceiver, and thus the console, was operable (Block 415). In this manner, a console-less boot can be achieved. The boot process can then initiate a loading of the operating system so that the computing system can be operable.

In another example of methodology 400, if a failed transceiver is detected at Block 405, a failed transceiver signal can be set that indicates that the transceiver has failed. The failed transceiver signal can then be read by the operating system to determine the presence of a failed transceiver. In one example, suppose the transceiver is a UART and the operating system identifies the UART by reading a UART path, which can be set during initialization. The UART path can be used as the failed transceiver signal such as by setting the path as null or another value that the operating system recognizes are identifying a failed UART. In response to reading the failed transceiver signal, the operating system can load a dummy transceiver driver configured to handle communications with the failed transceiver that are directed to the console. An example methodology of the foregoing is described with reference to FIG. 5.

Illustrated in FIG. 5 is an example methodology 500 that may be associated with an operating system. The operating system can be configured to perform the methodology 500 during an initialization stage or the like. The methodology 500 can include determining a failed console (Block 505). This may be performed by reading a failed signal that was previously set during system boot. A console driver can then be loaded that is configured to process communication requests to a failed console (Block 510). This may include loading a dummy console driver as previously described or loading a console driver that can accommodate a functioning and non-functioning console such as console driver 300 shown in FIG. 3. In this manner, a computing system can be made available for operation even with a non-functioning console.

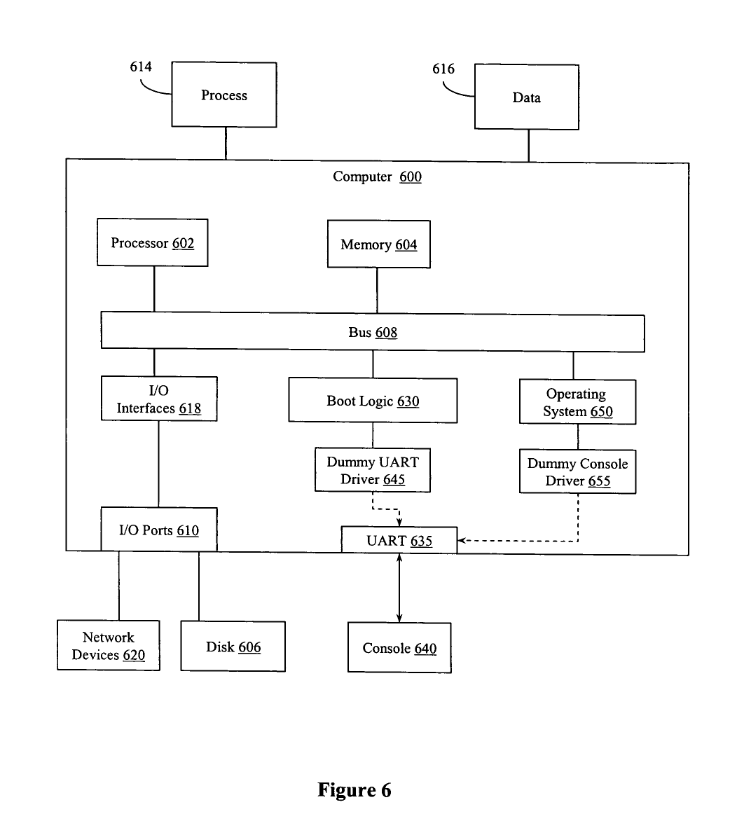

FIG. 6 illustrates an example computing device in which example systems and methods described herein, and equivalents, can operate. The example computing device may be a computer 600 that includes a processor 602, a memory 604, and input/output ports 610 operably connected by a bus 608. In one example, the computer 600 may include a boot logic 630 configured to facilitate a successful system boot even if a failed transceiver (e.g. UART 635) is present. The UART 635 controls communication to a console 640 The boot logic 630 can be implemented similar to the boot logic 110, 205 described in FIGS. 1 and 2, respectively, and/or the other systems and methods described herein, and their equivalents.

For example, the boot logic 630 can be configured to load a dummy UART driver 645 that allows the system boot to successfully initialize the UART 635 as though the UART 635 was functional. The dashed line between the dummy driver 645 and the UART 635 represents an imaginary operable communication link. As described in previous examples, an operating system 650 can then be loaded. Upon determining that the console 640 is not functioning (due to the failed UART 635), a dummy console driver 655 can be loaded to handle communication requests to the console 640. The dummy console driver 655 can be configured similar to previous driver examples described herein.

More generally describing an example configuration of the computer 600, the processor 602 can be a variety of various processors including dual microprocessor and other multi-processor architectures. The memory 604 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 606 may be operably connected to the computer 600 via, for example, an input/output interface (e.g., card, device) 618 and an input/output port 610. It will be appreciated that the UART 635 can be regarded as an I/O interface connected to an I/O port. The disk 606 can include, but is not limited to, devices like a magnetic disk drive, a solid state disk drive, a floppy disk drive, a tape drive, a Zip drive, a flash memory card, and/or a memory stick. Furthermore, the disk 606 can include optical drives like a CD-ROM, a CD recordable drive (CD-R drive), a CD rewriteable drive (CD-RW drive), and/or a digital video ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus or mesh architectures. While a single bus is illustrated, it is to be appreciated that computer 600 may communicate with various devices, logics, and peripherals using other busses that are not illustrated (e.g., PCIE, SATA, Infiniband, 1394, USB, Ethernet). The bus 608 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 may interact with input/output devices via i/o interfaces 618 and input/output ports 610. Input/output devices can include, but are not limited to, a keyboard, a microphone, a pointing and selection device, cameras, video cards, displays, disk 606, network devices 620, and the like. The input/output ports 610 can include but are not limited to, serial ports, parallel ports, and USB ports.

The computer 600 can operate in a network environment and thus may be connected to network devices 620 via the i/o devices 618, and/or the i/o ports 610. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network devices 620 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 620 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A system for a computing device that includes at least a console, the system comprising:
boot logic configured to detect whether communication with the console is functional or non-functional and to allow the computing device to boot with a non-functional console.

2. The system of claim 1 where a transceiver is configured to provide communication between the computing device and the console, the boot logic including:
detect logic being configured to detect a non-functional transceiver that causes the console to be non-functional; and
map logic being configured to map, in response to the detected non-functional transceiver, a dummy transceiver driver that allows the computing device to boot without communication with the console.

3. The system of claim 2, the transceiver being one of: a Universal Asynchronous Receiver/Transmitter (UART), and a virtual UART.

4. The system of claim 2, the boot logic being configured to provide a plurality of drivers including the dummy transceiver driver and a functional transceiver driver; and
the boot logic being configured to map the functional transceiver driver in response to detecting the transceiver as being functional.

5. The system of claim 2, in response to the non-functional transceiver being detected, the boot logic being configured to set a failed signal that is accessible by an operating system of the computing device; and
the failed signal being configured to cause the operating system to load a transceiver driver configured to allow the operating system to process communication requests directed to the console without transmitting data to the console.

6. The system of claim 5, the second dummy transceiver driver being configured to discard data that is requested to be transmitted to the console.

7. The system of claim 5, where the transceiver is a Universal Asynchronous Receiver/Transmitter (UART), and
where the boot logic is configured to write the failed signal in a UART path for the operating system that indicates a failed UART is to be handled.

8. The system of claim 1, the boot logic being configured as system firmware within the computing device.

9. The system of claim 1, further including a transceiver driver configured to process communications between the computing device and a transceiver that allows the computing device to boot without communication with the console

10. A computing system, comprising:
a console operably connected to the computing system and configured to at least display information;
a transceiver operably connected to the computing system and configured to provide communication between the computing system and the console;
system firmware configured to control a boot process of the computing system, the system firmware being configured to detect whether the transceiver is functional or non-functional; and
in response to the transceiver being detected as non-functional during the boot process, the system firmware being configured to load a transceiver driver operable to allow the boot process to continue as though the transceiver was functional.

11. The computing system of claim 10, the transceiver being a Universal Asynchronous Receiver/Transmitter (UART) or a virtual UART.

12. The computing system of claim 10 where the transceiver driver is a dummy driver.

13. The computing system of claim 10 further including an operating system being configured to load a dummy console driver in response to the transceiver being non-functional.

14. The computing system of claim 13, the dummy console driver being configured to discard data to be transmitted to the console.

15. The computing system of claim 10, the console being a display terminal.

16. The computing system of claim 10, where the system firmware includes means for continuing the boot process when the transceiver is detected as non-functional.

17. A computer-readable medium for providing processor executable instructions operable to perform a method during a system boot of a computing device, the method comprising:
detecting a failed transceiver, where the transceiver is configured to provide communication between the computing device and a console;
loading a transceiver driver that allows the system boot to continue when the failed transceiver is detected; and
continuing the system boot as though the transceiver was functional.

18. The computer-readable medium of claim 17 further including executable instructions operable to perform:
setting a failed transceiver signal that indicates that the transceiver has failed;
reading the failed transceiver signal by an operating system; and
in response to reading the failed transceiver signal, loading, by the operating system, a dummy transceiver driver configured to handle communications with the failed transceiver that are directed to the console.

19. The computer-readable medium of claim 17, where the loading includes loading a dummy transceiver driver to act as the transceiver driver.

20. A computer-readable medium, being part of an operating system, for providing processor executable instructions operable to perform a method, the method comprising:
detecting whether a console is functional or non-functional; and
loading a console driver in response to the console being non-functional, the console driver being configured to process data transmission requests to the console without transmitting data to the console.

21. The computer-readable medium of claim 17, the detecting includes reading a signal that is set during a system boot that indicates that the console is non-functional.

22. The computer-readable medium of claim 17, the detecting includes determining whether a transceiver is functional or non-functional where the transceiver operably connects the operating system and the console to provide communications therebetween.

23. A system, comprising:
means for detecting a failed UART (universal asynchronous receiver/transmitter) during a system boot; and
means for continuing the system boot as though the failed UART was functional.

24. The system of claim 23, where the means for continuing being configured to load a dummy driver for processing communications with the failed UART.

25. A method, comprising:
detecting a failed transceiver during a system boot of a computing system, where the transceiver is configured to provide communication between the computing device and a console;
loading a transceiver driver that allows the system boot to continue when the failed transceiver is detected; and
continuing the system boot as though the transceiver was functional.

26. The method of claim 24 where loading includes loading a dummy transceiver driver as the transceiver driver.
